(19) United States
(12) Patent Application Publication
(10) Pub. No.: US 2005/0112772 A1
(43) Pub. Date: May 26, 2005

(54) Measurement of oxidation-reduction potential of a solution

(76) Inventors: William A. Farone, Irvine, CA (US); Tracy Palmer, Coto de Caza, CA (US)

Correspondence Address: Cynthia H. O'Donohue;Applied Power Concepts, 411 East Julianna Street, Anaheim, CA, 92801, US

(21) Appl. No.: 10/718,326

(22) Filed: Nov. 20, 2003

(51) Int. Cl. G01N 21/00

(52) U.S. Cl. 436/151; 436/163; 436/164

(57) ABSTRACT

A novel method for measuring the oxidation-reduction potential of a solution is described using an indicator dye which changes electromagnetic absorbance over a range of oxidation-reduction potential.

### FIELD OF INVENTION

A novel means of using a dye sensitive to changes in the oxidation-reduction potential (ORP) of a solution is described. The method does not require the use of electrodes which can easily become contaminated and could require frequent recalibration. The described method can also be used either in a laboratory or in a remote location such as in a ground water well or a bioreactor via light absorbance measurements.

### BACKGROUND

The following description of the background is provided to aid in understanding the invention, but is not admitted to be, or to describe, prior art. All publications are incorporated by reference in their entirety.

For many years the measurement of oxidation-reduction potential (ORP) of solutions has experienced problems due to the difficulties in collecting samples without having the oxidation—reduction (redox) nature of the collected solution change during or by the collection process. As an example, a very small amount of air that could enter a sample during its collection process potentially could have a major effect on the measured ORP.

Most available measurement systems require removal of a sample from its environs. The usual methods for ORP measurement require the use of various types of electrodes. The electrodes are calibrated against standard redox reactions and then the measurement of the voltage can be used to relate the measured ORP to a calibration scale. The electrode method works well for aerobic conditions such as in cooling towers where the measured potential are high compared to aerated water. However, such measurements have been found to be more difficult in anaerobic situations. ORP measurements are also difficult where pH changes of the solutions are complicating factors.

The basis for the definition of the classical oxidation-reduction potential is based on the general chemistry of electrochemical reactions. This measurement is typically based on the concentration of electrons that are available in the solution. The concept is similar to the definition of pH where the pH is related to the concentration of hydrogen ions and the pH scale is defined by
pH=−log[H⁺] (1)
where [H⁺] is the thermodynamic activity of the hydrogen ion in the general case. For a typical dilute solution the thermodynamic activity is the same as the molar concentration of the hydrogen ion. Thus, for most acid and base solutions one uses the molar concentration of hydrogen ion to define the pH.

The value of pE is analogous to pH and is defined by:
pE=−log[e⁻] (2)
wherein e⁻ is the number of electrons with the potential to be exchanged.

The pE can be thought of as defining a scale for the concentration of electrons that are able to be transferred in a solution in much the same way as the pH defines the value for hydrogen ions. The classic ORP used in field-work is related to pE by multiplying the pE by 0.05915. This standard relationship allows the pE to be measured in millivolts using electrodes. In any solution the ORP (pE) and pH are related to the various redox pairs of ions in the solution through the general reaction given below:
mAₒₓ+nH⁺+e⁻=pA_{red}+qH₂O (3)
wherein A is the chemical species; ox represents the oxidized form and red represents the reduced form.

This is the classical redox half cell reaction and describes a reduction of the species Aₒₓ to the reduced state A_{red}. The general equation derived from the equilibrium expression is:

$$pE = log K - npH + log ( \frac{{[ Aox ]}^{m}}{{[ Ared ]}^{p}} ) \qquad ( 4 )$$

The ORP is therefore related to the equilibrium constant for any of the electrochemical reactions that could occur in that solution; i.e., the ratio of the reduced and oxidized species and the pH. The factors, m, n and p, are required for the equation to be mass and charge balanced (3).

The basic need is to simply make the measurement of ORP (pE) while causing the least change to the pH or the oxidized and reduced species in situ. Since oxygen is a potent oxidizing agent, keeping air out of the system when making anaerobic measurement of ORP (values below 0.00 mv) is crucial.

It is known that certain dyes can function as ORP indicators in a similar manner to which they can function as pH indicators. Table 1 is a table of a few dyes listed in “Lange's Handbook of Chemistry”, John Dean, editor, McGraw-Hill, 1972, pages 6-20 and 6-21.

These indicators are normally used in analytical chemical titrations wherein the color change serves as an indictor for the transition at the specified ORP. This is similar to the use of acid base indicators for titration. The indicator changes color at the completion of the desired reaction, in this case when the desired ORP is reached. See, for example, Chapter 15 titled “Oxidation—Reduction Titrations” in “Principles and Methods of Chemical Analysis” by Harold F. Walton, Prentice-Hall, Inc., 1957.

TABLE 1
Sample Redox Indicators at pH 7.0
Color Change upon Oxidation

| | ORP for Color | Color Change at |
|---|---|---|
| Indicator | Change (mv) | ORP |
| Indigo-5,5′-disulfonic acid | −125 | Colorless to Blue |
| (Na salt) | | |
| (Indigo Carmine) | | |
| Indigo-5-monosulfonic | −157 | Colorless to Blue |
| acid (Na salt) | | |
| Phenosafranine | −252 | Colorless to Violet |
| Safranine-T | −289 | Colorless to Violet |
| Induline scarlet | −299 | Colorless to Red |
| Neutral red | −323 | Colorless to Purple |
| Nile Blue A | −119 | Colorless to Blue |
| (aminoaphthodiethylamino- | | |
| phenoxazine sulfate) | | |
| Thionine (Lauth's Violet) | 64 | Colorless to Violet |
| Indigo-5,5′,7,7′- | −46 | Colorless to Blue |
| tetrasulfonic acid | | |
| (Potassium Salt) | | |
| Indigo-5,5′,7-trisulfonic | −81 | Colorless to Blue |
| acid (Potassium Salt) | | |

### SUMMARY

The present invention describes a method for measuring the oxidation-reduction potential of a solution comprising selecting an indicator dye wherein the dye changes electromagnetic absorbance over a range of oxidation-reduction potential. In one aspect a dye is selected from the group consisting of indigo carmine, thionine, potassium indigo trisulfonate, neutral red, potassium indigo tetrasulfonate, and nile blue. In another aspect the dye is indigo carmine.

In an additional aspect of the method the electromagnetic absorbance occurs in the region of electromagnetic spectrum selected from the group consisting of visible, near infrared, infrared and far infrared. In one aspect the electromagnetic absorbance occurs in the visible region. In another aspect the electromagnetic absorbance measurement wavelength is selected from the group consisting of 450 nm, 850 m, 1310 nm and 1550 nm. A further aspect is where the electromagnetic absorbance measurement wavelength is selected from the group consisting of 450 nm and 1550 nm.

The indicator dye may be embedded in a matrix selected from the group consisting of gelatin and carrageenan.

In an additional aspect the method for measuring the oxidation reduction potential of a solution comprises (1) selecting an indicator dye; (2) immobilizing the indicator dye on a matrix; (3) contacting the immobilized dye matrix with the solution; and (4) measuring the change in absorbance. In one aspect the indicator dye is selected from the group consisting of indigo carmine, thionine, potassium indigo trisulfonate, neutral red, potassium indigo tetrasulfonate, and nile blue. A further aspect is where the indicator dye is indigo carmine and the matrix is selected from the group consisting of gelatin and carrageenan. In another aspect the absorbance occurs in the region of spectrum selected from a group consisting of visible, near infrared, infrared and far infrared. In a further aspect the absorbance occurs in the visible region.

### DEFINITIONS

In accordance with the present invention and as used herein, the following terms are defined with the following meanings, unless explicitly stated otherwise.

The term “ORP” means oxidation reduction potential.

The term “red” in equations refers to the reduced form.

The term “ox” in equations refers to the oxidized form.

The term “redox” refers to oxidation-reduction.

### BRIEF DESCRIPTION OF DRAWINGS

FIG. 1 depicts the absorbance of indigo carmine at various wavelengths.

FIG. 2 depicts the ORP vs. Absorbance of indigo carmine at 450 nm.

FIG. 3 depicts the IR spectrum and 2 absorption peaks of indigo carmine.

FIG. 4 depicts an expansion of IR spectrum around 1.55μ (1550 nm) for indigo carmine.

FIG. 5 depicts the absorbance vs. ORP of indigo carmine at 1550 nm.

### DETAILED DESCRIPTION

One aspect was to make a strip that would contain various indicators. As the ORP changes a number of the indicators on the strip would change color. As an example, in Table 1 if the indicators of such a strip were placed in a solution at −200 mv there would be a color difference between the top two dyes and the bottom last four dyes if one assumed a pH of 7.0. The pH of the solution is a factor in the ORP reaction as shown in equation 4.

In order to make the “strips” as in the above example or to use these dyes in many of the devices possible under this method, it was useful to utilize a form wherein they are easily used in solution, are spread on strips or are used in spectrophotometric devices. It was found that the dyes can be immobilized in either gelatin or carrageenan. Gelatin immobilization was more water soluble than carrageenan immobilization and was useful for the strips in certain cases. In one aspect gelatin immobilization was useful wherein there was positive ORP when the water sample is applied to the strip. Carrageenan can be made into beads that can be used wherever the dye is desired or needed to be placed in a particular location.

The color changes of the dyes can be tested with ORP calibrating solutions. Calibrating solutions were developed for the range of 521 mv to −180 mv.

During the testing of the dyes it was found that some of the dyes did not change color abruptly as required for a titration indictor. When titrating one normally expects the color change to be sharp and abrupt and therefore some of the dyes would not have value for titration indication.

Surprisely we found that two or three of the dyes exhibit a continuous color change over the entire range of ORP. The utilization of these dyes would simplify the measurement process. In one aspect a single dye could be used for a wide range of ORP. In another aspect a useful dye appeared to be indigo carmine.

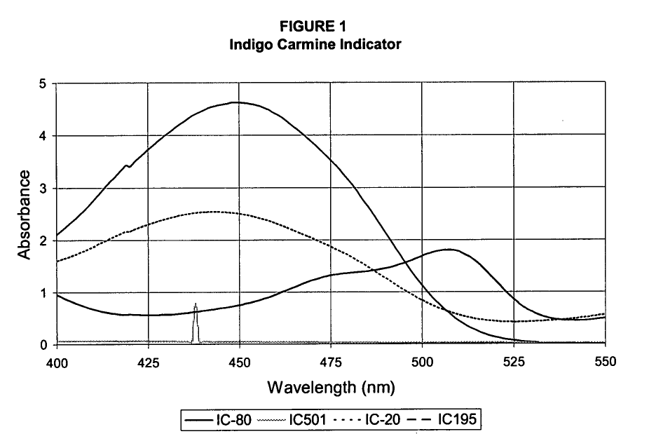

A portion of the visible spectrum is shown in FIG. 1. Around 450 nm (blue) there is a continuous change in absorption as the ORP changes. The ORP of the solutions are given in the legend from −80 mv to 521 mv. For the indigo carmine dye the absorbance increased as the ORP decreased. The indigo carmine dye was used in a manner similar to pH paper strips or used in conjunction with a simple calorimeter.

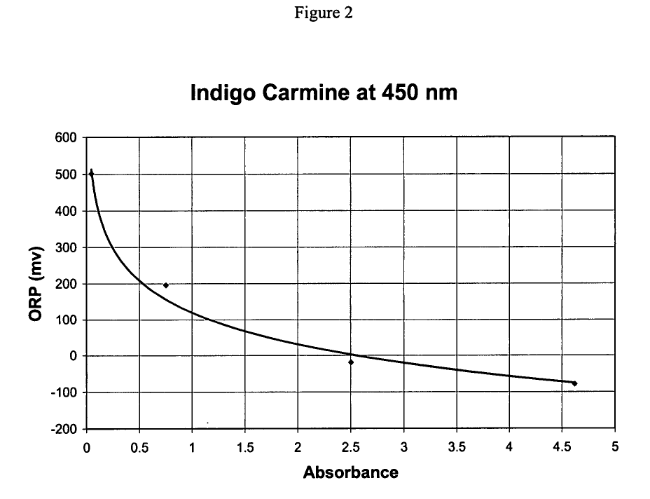

The plot of ORP vs. Absorbance at 450 nm in FIG. 2 is an example of how the indicator is used to measure ORP over the calibration range. One reads the Absorbance and then in one aspect a computer chip calculates the ORP that shows on a read out device or an individual manually uses the Absorbance from a general purpose instrument to calculate the ORP. As an example, but not limited to this means, a graph of the type of FIG. 2 was used. The graph could be calibrated with a varying ranges of ORP values.

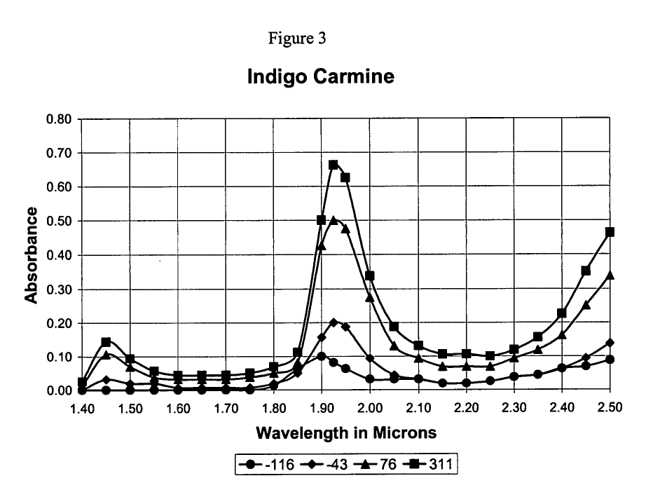

In an additional aspect these indicators have been found to be useful in the Infrared portion of the spectrum. FIG. 3 shows a portion of the IR spectrum. There are absorption peaks near 1.5μ and 1.9μ. The various curves were matched with the ORP at which they were measured. The curve with the greatest absorbance (top curve) is the spectrum when the ORP was +311 mv. The next highest curve was the spectrum when the ORP was +76 mv. The third highest curve was measured when the ORP was −43 mv and the lowest curve was measured when the ORP was −118 mv. Again there was a monotonic variation in absorbance with ORP that is used to measure the ORP using the Infrared wavelengths at which the indicator absorbed.

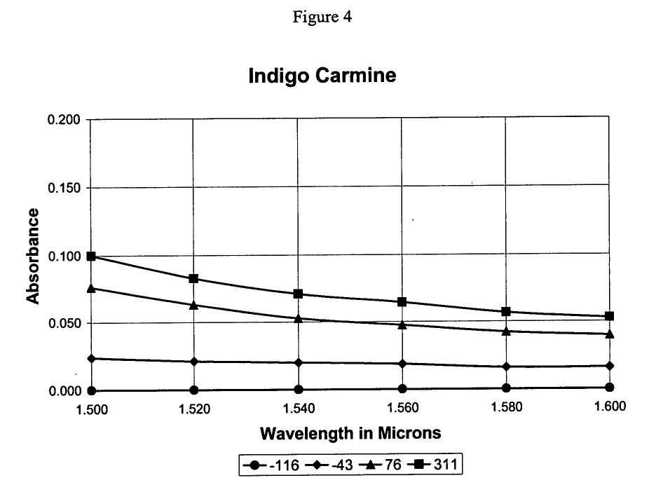

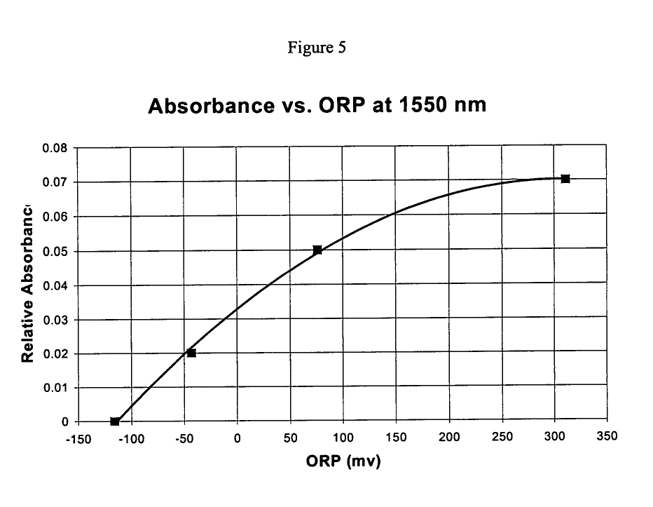

FIG. 4 is an expansion of the spectrum around 1.55μ (1550 nm). This unexpected result lead to the use of standard laser based fiber optics systems which are available at 1550 nm. One such system is manufactured by Fiber Instrument Sales, Inc. of Oriskany, N.Y. Their OV-PM Power Meter is capable of measuring the intensity of light that has traveled through a fiber cable at 850 nm, 1310 nm and 1550 nm. Using a long fiber optic cable a section in the approximate middle of the cable between a light source and the power meter is infused with the Indigo Carmine Dye in the carrageenan carrier. The section with the dye has pores to allow contact with water. The light traveling through the cable from source to power meter and passing through the dye responded with a relative signal as shown in FIG. 5.

With four calibration points used in FIG. 5, the second order fit was good and Indigo Carmine was found to be useful over the range of approximately −110 mv to 300 mv at this wavelength. The range of usefulness is approximately the same as in the visible region (see FIG. 2) but the equation and exact correlation is specific to the wavelength being used to measure the change in indicator structure.

The correlation equations depend on the path length and concentration of indicator. In one aspect the dye concentration and path length are determined to fit particular measuring systems. Commercially available measuring systems in the UV, Visible and Infrared can all be adapted to ORP measurement using this technique.

For the fiber optic system the sensing element with the embedded dye matrix can be placed at a significant distance from the source and detector. For example, this system could be used to measure the ORP of ground water at the bottom of wells. In one aspect this system would eliminate the problem of bringing the samples to the surface where the samples are contaminated with air (oxygen) which poses a significant problem for quick accurate measurement of ORP.

With samples at the surface or in a laboratory environ, simple UV, optical and Infrared systems can be converted to rapid ORP measurement.

### EXAMPLES

### Example A

### Preparation of Gelatin base for an ORP Indicator Dye

3.00 grams of gelatin was placed into a 250-ml beaker with a stir bar. Distilled water was added, 97.15 grams. The beaker was placed on a heating-stir plate. The temperature was set for 60 C. The mixture stirred until the gelatin was completely dissolved. The gelatin solution was removed from heat and used immediately.

### Example B

### Preparation of Carrageenan base for an ORP Indicator Dye

3.00 grams of carrageenan was placed into a 250-ml beaker with a stir bar. 98.5 grams of distilled water was added. The beaker was placed on a heating-stir plate. The temperature was set for 60 C. The mixture stirred until the carrageenan was completely dissolved. After the carrageenan was dissolved 0.5 grams of calcium chloride was added to the mixture. The carrageenan mixture was removed from heat and used immediately.

### Example C

### Use of Calibrating Solution to Calibrate the Visible Spectrum of an Indicator Dye

Different solutions with varying oxidation-reduction potentials were used to calibrate the UV—Visible Spectrometer. The following were the solutions used with their ORP that were measured using an ORP meter. The first was household bleach, which had an ORP of 501 mv. The second was a 5% solution of sodium metabisulfite with an ORP of 195 mv. The third solution was plain distilled water with an ORP of 138 mv. The fourth solution contained 3% Sodium sulfite and 1% Sodium thiosulfate with an ORP of −20 mv. The last calibration solution had an ORP of −80 mv, and was composed of a 3.84 N sodium hydroxide solution.

The indicator dyes were prepared by placing 0.1 g of the desired indicator in 100 ml of distilled water. They were heated gently on a hot plate until the indicator dissolved. The following indicators were measured using each of the above calibration solutions: Thionine, Potassium Indigotrisulfonate, Neutral Red, Indigo Carmine, Potassium Indigotetrasulfonate, Nile Blue. The absorbance of the indicator dyes was measured by putting three drops of the desired indicator into 3 milliliters of one of the calibration solution above and then the spectrum was run.

### Example D

### Use of Calibrating Solutions to Calibrate the IR Spectrum of an Indicator Dye

To calibrate the IR Spectrum Indigo Carmine was used. It was dissolved into different solutions that had different oxidation-reduction potentials. Six different solutions were used.

1) A distilled water solution of Indigo Carmine that had an ORP of 268 mv was used. This solution was made by adding 0.1 grams of indigo carmine to 100 milliliters of distilled water. The solution color was blue. The IR spectrum was measured.

2) A 2% sodium sulfite −1% sodium thiosulfate solution was prepared and sodium hydroxide was used to adjust the pH to 12. Three drops of the Indigo Carmine solution was added to 25 ml of the solution the ORP of the solution was −116 mv and the color changed to yellow. The IR spectrum was measured by placing one drop onto a potassium chloride salt plate.

3) A 10% sodium sulfite solution was also used, which gave an ORP of −43 mv. When the Indigo Carmine solution was placed into this solution there was a color changed to green.

4) A solution with an ORP of 76 mv was also used. It consisted of 1% sodium sulfite and 1% sodium metabisulfite in distilled water. When Indigo Carmine was added the color changed to light blue.

5) Household bleach was used which gave a high oxidation-reduction potential of 548 mv. When the dye was added to the bleach containing solution the color stayed clear. The bleach solution was diluted with distilled water until there was a 311 mv reading and upon addition of the dye the color turned blue.

### Example E

### Measurement Use of an Indicator Dye for ORP Measurement

It was found that one can drop the dye into a solution and observe the color change in order to determine the range of ORP or one could prepare slides that can be dipped into solution and the color on the slides change was dependent on the ORP. In one aspect for slide preparation it was found that carrageenan gave useable slides. To prepare the solution for the slide 0.2 grams of the desired indicator dye was added to 97.0 grams of distilled water. The mixture was heated at (60 C) and stirred until all of the dye dissolved. After the dye dissolved 3.0 grams of carrageenan was added. After the carrageenan was in solution 0.5 grams of calcium chloride was added. The mixture was immediately used after everything was dissolved. The solution was applied to the slides by wiping a thin strip onto each slide. Different indicator dyes were applied to one slide. Carrageenan beads containing the dye were also prepared and used. In another aspect the beads are suitable for remote measurement and by including the bead and dye in contact with the solution in the path length of optical or IR equipment.

### Example F

### Selection of an Indicator Dye

Different indicator dyes were examined. 12 different dyes were placed into five different solutions with varying ORP. The dyes that showed distinct color changes but that also varied over the different oxidation-reduction potentials were selected. To exemplify without limiting the scope, Indigo Carmine is blue in distilled water, and with decreasing ORP, the color will change from blue to green and then to yellow. This range of color change with ORP indicated it was more useful for this application than a dye that changed color abruptly at one ORP. As the ORP increases, the color will change from blue to grey to clear. Another example of a good indicator dye was Nile blue. In distilled water it is blue, and with decreasing ORP the dye will change to violet and then to pink. Increases in ORP will cause the color to change from blue to light blue and eventually to clear.

As exemplified in the preceding examples the aspects of a novel method for measuring the ORP of a solution under varying conditions consists pf selecting an indicator dye whose electromagnetic absorbance changes over a range of ORP when contacted with solutions of varying ORP is selected for the desired ORP range. It was found in another aspect that if the indicator dye was immobilized in a matrix suitable for the solution to be measured such that the matrix can contain the dye for a sufficient period of time to allow the desired ORP range to be measured.

The immobilized dye was calibrated for use in the range of wavelengths identified above with various calibrating solutions. The dye concentration and path length were fixed such that a correlating equation was used to relate ORP and Absorbance in the same system repetitively. After this calibration other portions of the batch of immobilized dye or even another batch can be used providing none of the parameters (wavelength, measurement system, path length, dye concentration) change.

The immobilized dye system was used to measure ORP by contacting the solution to be measured with the dye and measuring the change in absorbance using the equations or graphs developed in calibration to relate Absorbance to ORP.

1. A method for measuring the oxidation-reduction potential of a solution comprising selecting an indicator dye wherein the dye changes electromagnetic absorbance over a range of oxidation-reduction potential.

2. The dye of claim 1 wherein said dye is selected from the group consisting of indigo carmine, thionine, potassium indigo trisulfonate, neutral red, potassium indigo tetrasulfonate, and nile blue.

3. The dye of claim 2 wherein said dye is indigo carmine.

4. The method of claim 1 wherein the wherein the electromagnetic absorbance occurs in the region of electromagnetic spectrum selected from a group consisting of visible, near infrared, infrared and far infrared.

5. The method of claim 4 wherein said electromagnetic absorbance occurs in the visible region.

6. The method of claim 1 wherein the electromagnetic absorbance measurement wavelength is selected from the group consisting of 450 nm, 850 m, 1310 nm and 1550 nm.

7. The method of claim 6 wherein said electromagnetic absorbance measurement wavelength is selected from the group consisting of 450 nm and 1550nm.

8. A method of immobilizing said dye of claim 1 comprising, embedding said dye in a matrix.

9. The method of claim 8 wherein said matrix is selected from the group consisting of gelatin and carrageenan.

10. A method of measuring the oxidation reduction potential of a solution, comprising;
selecting an indicator dye;
immobilizing said indicator dye on a matrix;
contacting the immobilized dye matrix with said solution; and
measuring the change in absorbance.

11. The method of claim 10 wherein said indicator dye is selected from the group consisting of indigo carmine, thionine, potassium indigo trisulfonate, neutral red, potassium indigo tetrasulfonate, and nile blue.

12. The method of claim 11 wherein said indicator dye is indigo carmine.

13. The method of claim 10 wherein said matrix is selected from the group consisting of gelatin and carrageenan.

14. The method of claim 10 wherein the wherein the absorbance occurs in the region of spectrum selected from a group consisting of visible, near infrared, infrared and far infrared.

15. The method of claim 14 wherein said absorbance occurs in the visible region.
